(19) United States
(12) Patent Application Publication
(10) Pub. No.: US 2026/0131796 A1
(43) Pub. Date: May 14, 2026

(54) LEARN DRIVER ACCELERATION SYSTEM FOR A VEHICLE

(71) Applicant: GM Global Technology Operations LLC, Detroit, MI (US)

(72) Inventors: Kevin A. O'Dea, Ann Arbor, MI (US); Mohammadali Shahriari, Markham (CA); Paul A. Stanowski, Trenton, MI (US); Ashraf Abualfellat, Grand Blanc, MI (US)

(73) Assignee: GM Global Technology Operations LLC, Detroit, MI (US)

(21) Appl. No.: 18/946,085

(22) Filed: Nov. 13, 2024

(51) Int. Cl. B60W 50/00; B60W 40/09; B60W 40/105

(52) U.S. Cl. CPC B60W 50/0098; B60W 40/09; B60W 40/105; B60W 2050/0083; B60W 2510/0657; B60W 2520/10

(57) ABSTRACT

A computer-implemented method when executed by data processing hardware causes the data processing hardware to perform operations. The operations include receiving, at a learn driver acceleration application, one or more of vehicle parameters and environmental parameters, estimating, based on at least one of the vehicle parameters and the environmental parameters, a set speed of a vehicle, generating, based on the estimated set speed of the vehicle, a delta velocity, and estimating, based on at least one of the vehicle parameters and the environmental parameters, a requested torque. The operations also include determining, based on the estimated requested torque, a longitudinal acceleration of the vehicle, generating, via the learn driver acceleration application, learned acceleration tables based on at least one of the delta velocity, the requested torque, and the longitudinal acceleration of the vehicle, and replacing, via the learn driver acceleration application, calibration tables with the generated learned acceleration tables.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an acceleration system for a vehicle and more specifically to a learn driver acceleration system for a vehicle.

Many vehicles are equipped with adaptive or active cruise control functions. For example, the active cruise control may be utilized to adjust and maintain a speed of the vehicle with minimal inputs from the driver. The driver may adjust a speed of the active cruise control through manual manipulation or may override the active cruise control through braking or acceleration. The active cruise control is calibrated based on an average comfortability set during manufacturing, such that the active cruise control is generally not customized for the driver of the vehicle. At most, the driver may customize the active cruise control by setting a speed of the vehicle. However, there is a need for an improved system that learns and adapts to preferences of a driver with respect to accelerating the vehicle.

### SUMMARY

In some aspects, a computer-implemented method when executed by data processing hardware causes the data processing hardware to perform operations. The operations include receiving, at a learn driver acceleration application, one or more of vehicle parameters and environmental parameters, estimating, based on at least one of the vehicle parameters and the environmental parameters, a set speed of a vehicle, generating, based on the estimated set speed of the vehicle, a delta velocity, and estimating, based on at least one of the vehicle parameters and the environmental parameters, a requested torque. The operations also include determining, based on the estimated requested torque, a longitudinal acceleration of the vehicle, generating, via the learn driver acceleration application, learned acceleration tables based on at least one of the delta velocity, the requested torque, and the longitudinal acceleration of the vehicle, and replacing, via the learn driver acceleration application, calibration tables with the generated learned acceleration tables.

In some examples, the learned acceleration tables may include a learned average acceleration table and a learned maximum acceleration table and the calibration tables may include an acceleration request table and a calibrated maximum acceleration table. Optionally, replacing the calibration tables with the learned acceleration tables may include replacing the calibrated maximum acceleration table with the learned maximum acceleration table. The operations may also include determining, based on the learned acceleration tables and the calibration tables, an average ratio. The operations may also include generating, based on the determined average ratio, a scaled acceleration table.

Optionally, replacing the calibration tables with the learned acceleration tables may include determining, via the learn driver acceleration application, whether to use the learned average acceleration table or the scaled acceleration table. In some instances, the vehicle parameters may include speed parameters. In some examples, generating the delta velocity may include generating the delta velocity based on the speed parameters. The operations may further include generating, via the learn driver acceleration application, the learned acceleration tables based on the delta velocity.

In other aspects a learn driver acceleration system includes data processing hardware and memory hardware in communication with the data processing hardware. The memory hardware stores instructions that when executed on the data processing hardware cause the data processing hardware to perform operations. The operations include receiving, at a learn driver acceleration application, one or more of vehicle parameters and environmental parameters, estimating, based on at least one of the vehicle parameters and the environmental parameters, a set speed of a vehicle, and generating, based on the estimated set speed of the vehicle, a delta velocity. The operations also include estimating, based on at least one of the vehicle parameters and the environmental parameters, a requested torque and determining, based on the estimated requested torque, a longitudinal acceleration of the vehicle. The operations further include generating, via the learn driver acceleration application, learned acceleration tables based on at least one of the delta velocity, the requested torque, and the longitudinal acceleration of the vehicle and replacing, via the learn driver acceleration application, calibration tables with the generated learned acceleration tables.

In some examples, the learned acceleration tables may include a learned average acceleration table and a learned maximum acceleration table and the calibration tables may include an acceleration request table and a calibrated maximum acceleration table. Optionally, replacing the calibration tables with the learned acceleration tables may include replacing the calibrated maximum acceleration table with the learned maximum acceleration table. The operations may also include determining, based on the learned acceleration tables and the calibration tables, an average ratio. The operations may further include generating, based on the determined average ratio, a scaled acceleration table. Optionally, replacing the calibration tables with the learned acceleration tables may include determining, via the learn driver acceleration application, whether to use the learned average acceleration table or the scaled acceleration table. In some instances, the vehicle parameters may include speed parameters.

In further aspects, a learn driver acceleration system for a vehicle includes data processing hardware and memory hardware in communication with the data processing hardware. The memory hardware stores instructions that when executed on the data processing hardware cause the data processing hardware to perform operations. The operations include receiving, at a learn driver acceleration application, one or more of vehicle parameters and environmental parameters, estimating, based on at least one of the vehicle parameters and the environmental parameters, a set speed of a vehicle, and generating, based on the estimated set speed of the vehicle, a delta velocity. The operations also include estimating, based on at least one of the vehicle parameters and the environmental parameters, a requested torque, determining, based on the estimated requested torque, a longitudinal acceleration of the vehicle, and generating, via the learn driver acceleration application, learned acceleration tables based on at least one of the delta velocity, the requested torque, and the longitudinal acceleration of the vehicle, the learned acceleration tables including a learned average acceleration table and a learned maximum acceleration table. The operations further include replacing, via the learn driver acceleration application, a calibrated maximum table of calibration tables of a cruise control system with the generated learned maximum acceleration table, determining, based on the learned acceleration tables and the calibration tables, an average ratio, and generating, based on the determined average ratio, a scaled acceleration table.

In some examples, the operations may include determining, via the learn driver acceleration application, whether to use the learned average acceleration table or the scaled table. Optionally, the vehicle parameters may include speed parameters and generating the delta velocity includes generating the delta velocity based on the speed parameters. The operations may further include generating, via the learn driver acceleration application, the learned acceleration tables based on the delta velocity.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with a learn driver acceleration system according to the present disclosure;

FIG. 2 is an exemplary block diagram of a learn driver acceleration system according to the present disclosure;

FIG. 3 is another block diagram of the learn driver acceleration system of FIG. 2;

FIG. 4 is a further block diagram of the learn driver acceleration system of FIG. 2;

FIG. 5 is an exemplary flow diagram of a learn driver acceleration system according to the present disclosure;

FIG. 6 is another exemplary flow diagram of the learn driver acceleration system of FIG. 5;

FIG. 7 is a further exemplary flow diagram of a learn driver acceleration system according to the present disclosure; and

FIG. 8 is an exemplary flow diagram of a method for executing a learn driver acceleration system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

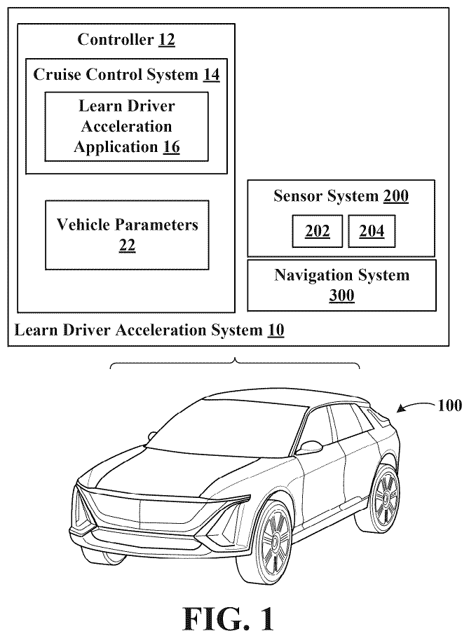

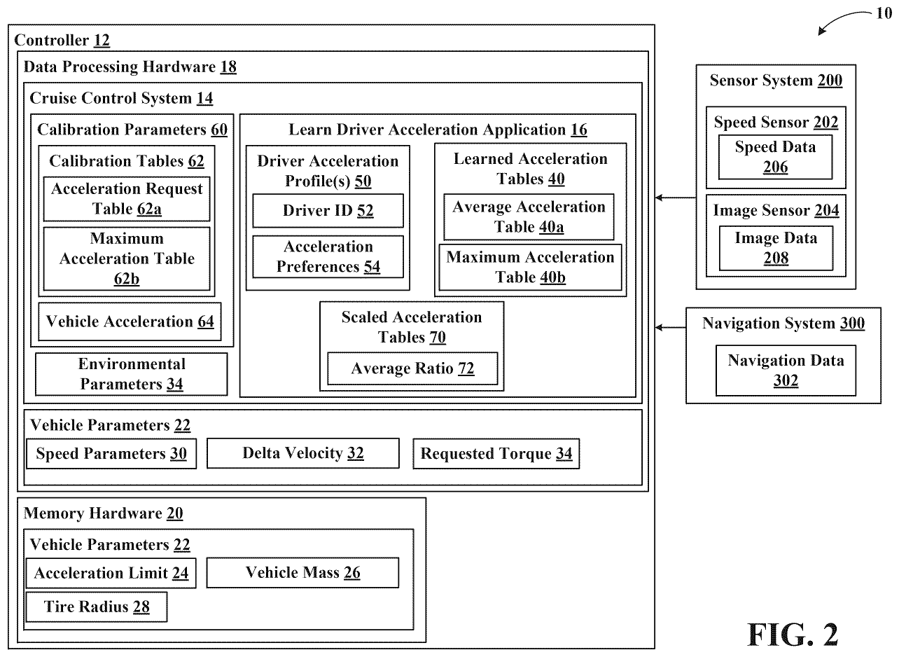

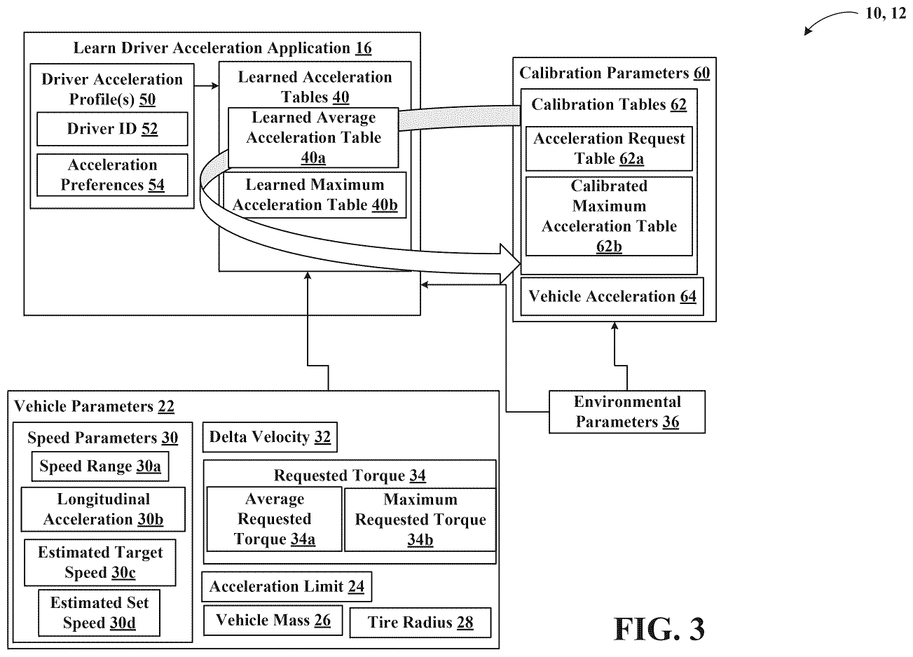

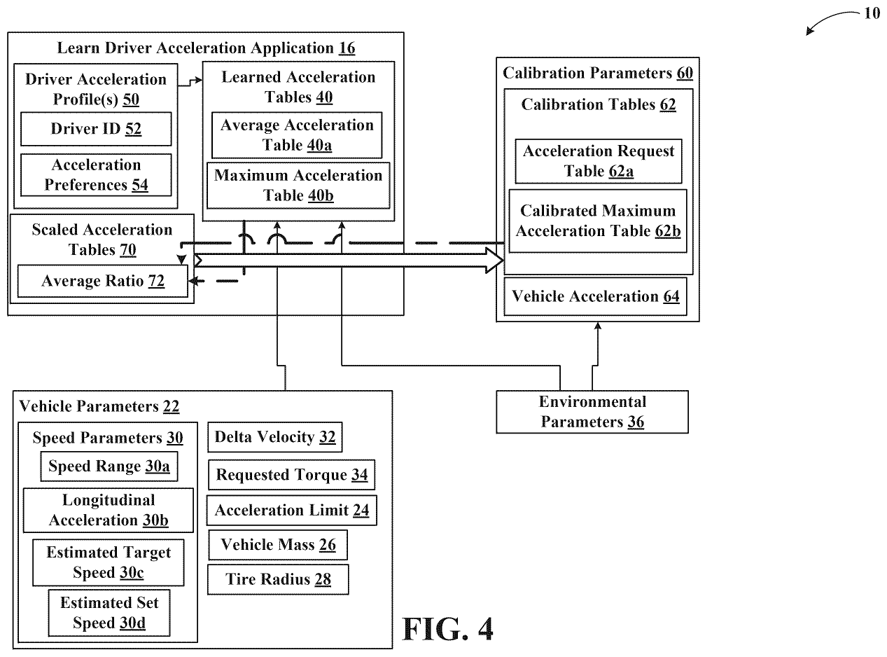

Referring to FIGS. 1-4, a learn driver acceleration system 10 includes a controller 12 configured with a cruise control system 14. The cruise control system 14 is configured for a vehicle 100 to regulate an acceleration of the vehicle 100 and maintain a speed set by a driver of the vehicle 100. The cruise control system 14 includes a learn driver application 16, which is configured to automatically adjust the acceleration of the vehicle 100 by utilizing one or both of a sensor system 200 and a navigation system 300 equipped at the vehicle 100. For example, the sensor system 200 may include a speed sensor 202 and an image sensor 204, which may provide speed data 206 and image data 208 to the cruise control system 14 for use by the learn driver acceleration application 16.

In some instances, the speed sensor 202 may be a torque sensor and/or an accelerometer integrated into the vehicle 100, such that the speed data 206 may include one or both of torque data 206a and acceleration data 206b. The image data 208 may include environmental surroundings of the vehicle 100 including, but not limited to, road grade, road surface, road type, traffic conditions, and any other environmental related data captured by the image sensor 204. The image sensor 204 may include, but is not limited to, a camera, Light Detection and Randing (LiDAR), radar, or any other practicable imaging device. The vehicle 100 may be equipped with one or more of each of the speed sensor 202 and the image sensor 204.

The vehicle 100 may also be equipped with the navigation system 300, which may provide the controller 12 with navigation data 302. The navigation data 302 may also provide information related to environmental conditions surrounding the vehicle 100 or areas through which the vehicle 100 may be traveling. The controller 12 may receive and utilize the image data 208 and the navigation data 302 to inform the learn driver acceleration application 16, described in more detail below. The controller 12 is also configured with data processing hardware 18 and memory hardware 20. The data processing hardware 18 is configured to execute the cruise control system 14, including the learn driver acceleration application 16. The memory hardware 20 is in communication with the data processing hardware 18 and stores instructions that when executed on the data processing hardware 18 cause the data processing hardware 18 to perform operations, described herein. The memory hardware 20 is also configured to store vehicle parameters 22 and communicate the vehicle parameters 22 with the data processing hardware 18.

Some of the vehicle parameters 22 are stored on the memory hardware 20, while some of the vehicle parameters 22 are gathered through the sensor data 206 and/or image data 208 and executed by the data processing hardware 18. For example, the memory hardware 20 stores an acceleration limit 24, a vehicle mass 26, and a tire radius 28. In some instances, the acceleration limit 24 may be set or otherwise modified by a user of the vehicle 100. In other instances, the acceleration limit 24 may be preset. The controller 12 may estimate the vehicle mass 26 and/or the tire radius 28 or may have the vehicle mass 26 and/or tire radius 28 preconfigured in the memory hardware 20. The vehicle parameters 22 also include speed parameters 30 that may be determined by the data processing hardware 18 based on other vehicle parameters 22 and/or the speed data 206 from the sensor system 200. The speed parameters 30 are utilized to generate a delta velocity 32. For example, the speed parameters 30 may include a speed range 30a, a longitudinal acceleration 30b of the vehicle 100, an estimated target speed 30c, and an estimated set speed 30d. The vehicle parameters 22 also include a requested torque 34, which is captured from the speed data 206 and/or from the speed sensors 202, mentioned above.

The speed range 30a is determined based on the speed data 206 as a range of speeds of the vehicle 100 over a predetermined period of time, which may be informed at least in part by the longitudinal acceleration 30b of the vehicle 100. The learn driver acceleration application 16 may be utilized by the data processing hardware 18 to estimate the estimated target speed 30c based on other vehicle parameters 22 and environmental parameters 36. The environmental parameters 36 are configured based on the image data 208 and/or the navigation data 302.

The estimated set speed 30d is also a function of the environmental parameters 36. For example, the estimated set speed 30d may vary depending on the road type, speed limit, and/or traffic, which are captured by the sensor system 200 and the navigation system 300 and stored as the environmental parameters 36. The learn driver acceleration application 16 also monitors, for example, the requested torque 34 of the vehicle parameters 22 to estimate the set speed 30d. The requested torque 34 is a function of the applied acceleration by a driver of the vehicle 100 and is captured as part of the speed data 206 by the speed sensor 202. The learn driver acceleration application 16 records the requested torque 34 and utilizes the vehicle mass 26, the tire radius 28, and the environmental parameters 36 to capture the requested torque 34 at various speeds within the speed range 30a.

The learn driver acceleration application 16 receives the vehicle parameters 22 and the environmental parameters 36 and estimates the set speed 30d, which is utilized to generate the delta velocity 32 of the vehicle parameters 22. The delta velocity 32 may be generated based on the estimated set speed 30d and the estimated target speed 30c relative to the speed range 30a. Further, the vehicle parameters 22 and the environmental parameters 36 may be utilized to estimate the requested torque 34, which may be utilized by the cruise control system 14 to determine the longitudinal acceleration 30b. The vehicle parameters 22 and the environmental parameters 36 are also utilized by the learn driver acceleration application 16 to generate learned acceleration tables 40. For example, the learned acceleration tables 40 may be generated, at least in part, based on the delta velocity 32, the requested torque 34, and the longitudinal acceleration 30b of the vehicle 100.

The learned acceleration tables 40 include a learned average acceleration table 40a and a learned maximum acceleration table 40b. The learn driver application 16 also includes driver acceleration profiles 50 that include a driver identification (ID) 52 and acceleration preferences 54. The driver acceleration profiles 50 may be utilized by the learn driver acceleration application 16 to estimate the target speed 30c and the set speed 30d based on the acceleration preferences 54 associated with the driver ID 52. The cruise control system 14 also includes calibration parameters 60 that include calibration tables 62. The calibration tables 62 are utilized by the learn driver acceleration application 16 in comparison with the learned acceleration tables 40. For example, the calibration tables 60 include an acceleration request table 62a and a calibrated maximum acceleration table 62b. The calibration parameters 60 also include a vehicle acceleration 64, which is gathered from the speed parameters 30 of the vehicle parameters 22. In addition, the learn driver acceleration application 16 utilizes both the learned acceleration tables 40 and the calibration tables 62 to generate scaled acceleration tables 70 based on an average ratio 72. The average ratio 72 is utilized by the learn driver acceleration application 16 to generate the scaled acceleration tables 70.

Referring still to FIGS. 1-4, the learn driver acceleration system 10 is operable during operation of the vehicle 100, such that the learn driver acceleration application 16 is continuously monitoring and learning the acceleration preferences 54 of a respective driver ID 52 based on the speed data 206 received from the speed sensor 202. For example, each driver ID 52 is associated with a respective driver acceleration profile 50, such that the learn driver acceleration application 16 knows which acceleration preferences 54 to implement based on the driver ID 52. The driver ID 52 may be associated with a key fob, an online profile, or any other means of identifying a specific driver. In some instances, the driver ID 52 may be determined by the image data 208 from an interior image sensor 204 capable of capturing image data 208 of a driver of the vehicle 100. In some examples, a user may input some acceleration preferences 54 into the driver acceleration profile 50.

The learn driver acceleration application 16 automatically monitors the vehicle parameters 22 and the environmental data 36 to continuously estimate the set speed 30d and the target speed 30c. The estimated set speed 30d and target speed 30c may be utilized by the learn driver acceleration application 16 to populate the acceleration preferences 54 of the driver acceleration profile 50. The learn driver acceleration application 16 records the requested torque 34 and the delta velocity 32 across the speed range 30a during manual operation (i.e., driving) of the vehicle 100 to capture the acceleration preferences 54 for the driver acceleration profile 50. For example, the cruise control system 14 may capture a maximum requested torque 34 at each speed range 30a during manual operation of the vehicle 100. The learn driver acceleration application 16 is thus operable only during manual operation of the vehicle 100 and is inoperable during an active cruise control function of the vehicle 100. The learn driver acceleration application 16 may also be operable when a driver is overriding the longitudinal acceleration 30b of the vehicle 100, such that the vehicle 100 may exceed a speed set as part of an active cruise control of the vehicle 100.

The learn driver acceleration application 16 is configured to monitor behavior of a driver by monitoring the requested torque 34 and delta velocity 32 at the various speed ranges 30a to determine the acceleration preferences 54 of the driver. The learn driver acceleration application 16 is configured to convert the requested torque 34 to acceleration for compatibility with the cruise control system 14. For example, the longitudinal acceleration 30b of the vehicle 100 is based on a fraction of the requested torque 34, the tire radius 28, and the vehicle mass 26 with a road grade 36 removed. The learn driver acceleration application 16 populates the learned maximum acceleration table 40b based on maximum requested torque 34a. The learned average acceleration table 40a is populated based on the delta velocity 32 and average requested torque 34b.

Once the learned acceleration tables 40 are populated, the learn driver acceleration application 16 may replace the calibration tables 60 with the learned acceleration tables 40. For example, the learn driver acceleration application 16 may replace the calibrated maximum acceleration table 62b with the learned maximum acceleration table 40b and the acceleration request table 62a with the learned average acceleration table 40a. As mentioned above, the learn driver acceleration application 16 may generate an average ratio 72 by creating a ratio of the learned acceleration tables 40 with the calibration tables 62. For example, the learn driver acceleration application 16 may determine whether to use the learned average acceleration table 40a or the scaled table 70 before replacing the acceleration request table 62a. In some instances, the learn driver acceleration application 16 may utilize the scaled acceleration tables 70. The scaled acceleration tables 70 are the calibration tables 62 scaled, via the average ratio 72, relative to the learned acceleration tables 40.

With further reference to FIGS. 1-4, the learn driver acceleration application 16 utilizes the acceleration limit 24 to enforce a maximum acceleration 24a for the vehicle 100, such that the acceleration preferences 54 cannot exceed the maximum acceleration 24a and/or the acceleration limit 24 of the vehicle 100. The acceleration limit 24 may also be informed by limits of an engine of the vehicle 100. The vehicle 100 may be configured as an electric vehicle, a hybrid vehicle, and/or a vehicle equipped with an internal combustion engine (ICE). The engine components may set an acceleration limit 24 that may influence the ability of the acceleration of the vehicle 100.

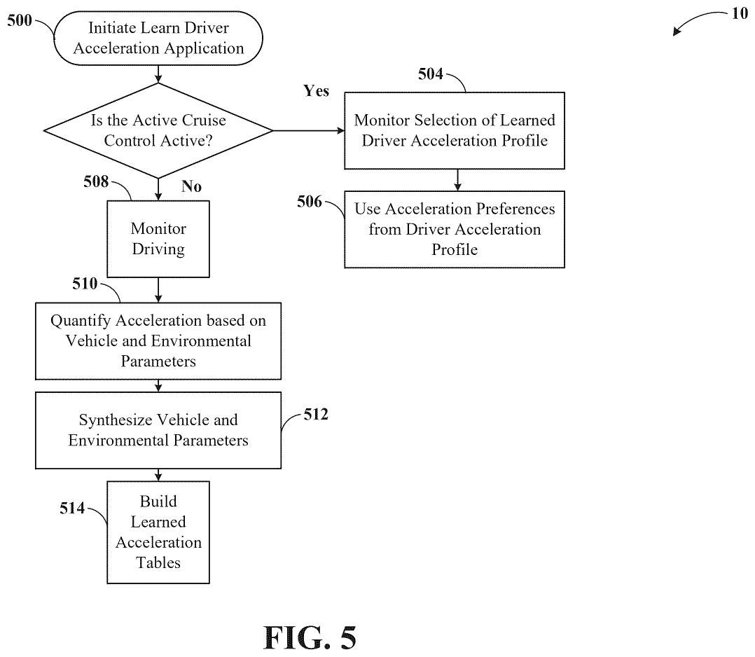

Referring now to FIG. 5, an exemplary flow diagram of the learn driver acceleration system 10 is illustrated. At 500, the learn driver acceleration application 16 is initiated. The learn driver acceleration application 16 determines, at 502, whether an active cruise control of the cruise control system 14 is active. If the active cruise control is active, then the controller 12 monitors, at 504 for selection of a learned driver acceleration profile 50. Based on selection of a driver acceleration profile 50, the controller 12 implements and uses the acceleration preferences 54 from the driver acceleration profile 50.

If the active cruise control is inactive, then the learn driver acceleration application 16 monitors driving of the vehicle 100 and quantifies, at 510, acceleration of the vehicle 100 based on vehicle parameters 22 and environmental parameters 36. At 512, the learn driver acceleration application 16 synthesizes the vehicle and environmental parameters 22, 36 and, at 514, builds the learned acceleration tables 40.

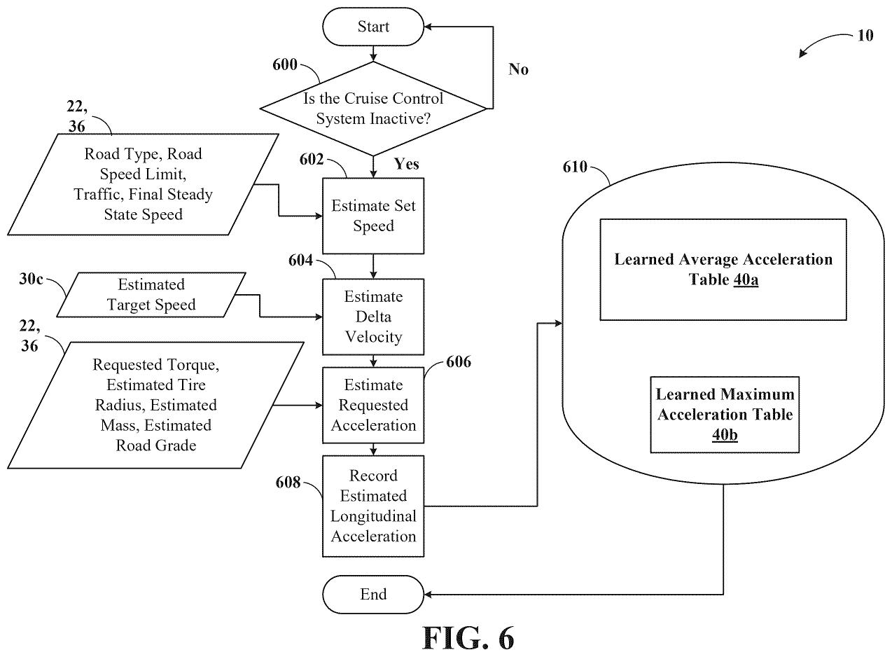

Referring now to FIG. 6, an exemplary flow diagram of the learn driver acceleration system 10 is illustrated. At 600, the controller 12 determines whether the cruise control system 14 is inactive. If the cruise control system 14 is active, then the controller 12 continues to monitor for whether the cruise control system 14 is inactive or whether the driver overrides the cruise control system 14. If the cruise control system 14 is inactive or the driver overrides the cruise control system 14, then the learn driver acceleration application 16 estimates, at 602, the set speed 30d of the vehicle 100 based on the vehicle parameters 22 and environmental parameters 36. At 604, the learn driver acceleration application 16 estimates a delta velocity 32 based on the estimated set speed 30 d and the estimated target speed 30 c and, at 606, estimates the requested acceleration. The requested acceleration corresponds to the requested torque 34 and is estimated based on the vehicle parameters 22 and the environmental parameters 36. At 608, the learn driver acceleration application 16 records the estimated longitudinal acceleration 30b, determined based on the estimated delta velocity 32 and estimated requested acceleration. At 610, the learn driver acceleration application 16 generates the learned acceleration tables 40 including the learned average acceleration table 40a and the learned maximum acceleration table 40b.

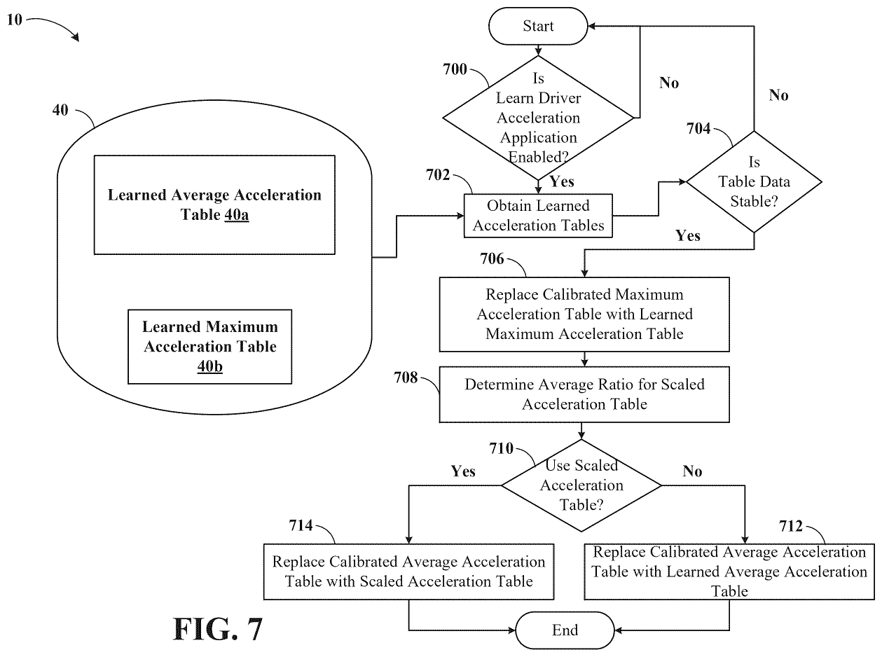

Referring now to FIG. 7, a continue flow diagram of the learn driver acceleration 10 is illustrated. At 700, the controller 12 determines whether the learn driver acceleration application 16 is enabled. If the learn driver acceleration application 16 is enabled, then the controller 12 obtains, at 702, the learned acceleration tables 40 and determines, at 704, whether the table data is stable. If the table data is not stable, the controller 12 returns to monitoring the learn driver acceleration application 16. If the table data is stable, the controller 12 replaces, at 706, the calibrated maximum acceleration table 62b with the learned maximum acceleration table 40b. At 708, the learn driver acceleration application 16 determines the average ratio 72 for the scaled acceleration table 70. The learn driver acceleration application 16 determines, at 710, whether to use the scaled acceleration table 70. If the learn driver acceleration application 16 determines not to use the scaled acceleration table 70, then the learn driver acceleration application 16 replaces, at 712, the calibrated average acceleration table 62 a with the learned average acceleration table 40a. If the learn driver acceleration application 16 determines to use the scaled acceleration table 70, then the learn driver acceleration application 16 replaces, at 714, the calibrated average acceleration table 62a with the scaled acceleration table 70.

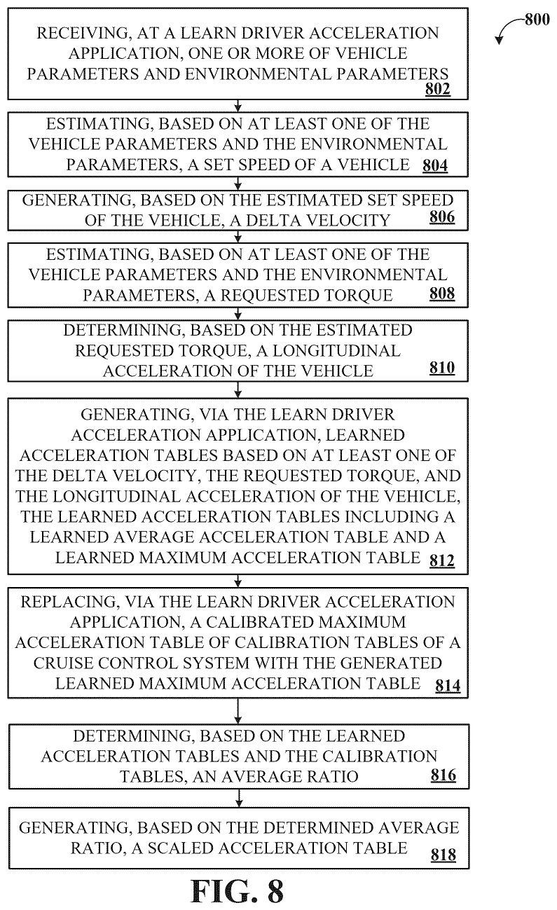

Referring now to FIG. 8, an example method 800 for the learn driver acceleration system 10 is illustrated. At 802, the learn driver acceleration application 16 receives one or more of vehicle parameters 22 and environmental parameters 36 and estimates, at 804, based on at least one of the vehicle parameters 22 and the environmental parameters 36, a set speed 30d of a vehicle 100. The learn driver acceleration application 16 generates, at 806, based on the estimated set speed 30 d of the vehicle 100, a delta velocity 32 and estimates, at 808, based on at least one of the vehicle parameters 22 and the environmental parameters 36, a requested torque 34. At 810, the learn driver acceleration application 16 determines, based on the estimated requested torque 34, a longitudinal acceleration 30 b of the vehicle 100. At 812, the learn driver acceleration application 16 generates learned acceleration tables 40 based on at least one of the delta velocity 32, the requested torque 34, and the longitudinal acceleration 30b of the vehicle 100. The learned acceleration tables 40 include a learned average acceleration table 40a and a learned maximum acceleration table 40 b. At 814, the learn driver acceleration application replaces a calibrated maximum table 62b of calibration tables 62 of a cruise control system 14 with the generated learned maximum acceleration table 62 b and determines, at 816, based on the learned acceleration tables 40 and the calibration tables 62, an average ratio 72. At 818, the learn driver acceleration application 16 generates, based on the determined average ratio 72, a scaled acceleration table 70.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a learn driver acceleration application, one or more of vehicle parameters and environmental parameters;
estimating, based on at least one of the vehicle parameters and the environmental parameters, a set speed of a vehicle;
generating, based on the estimated set speed of the vehicle, a delta velocity;
estimating, based on at least one of the vehicle parameters and the environmental parameters, a requested torque;
determining, based on the estimated requested torque, a longitudinal acceleration of the vehicle;
generating, via the learn driver acceleration application, learned acceleration tables based on at least one of the delta velocity, the requested torque, and the longitudinal acceleration of the vehicle; and
replacing, via the learn driver acceleration application, calibration tables with the generated learned acceleration tables.

2. The method of claim 1, wherein the learned acceleration tables include a learned average acceleration table and a learned maximum acceleration table and the calibration tables include an acceleration request table and a calibrated maximum acceleration table.

3. The method of claim 2, wherein replacing the calibration tables with the learned acceleration tables includes replacing the calibrated maximum acceleration table with the learned maximum acceleration table.

4. The method of claim 2, further including determining, based on the learned acceleration tables and the calibration tables, an average ratio.

5. The method of claim 4, further including generating, based on the determined average ratio, a scaled acceleration table.

6. The method of claim 5, wherein replacing the calibration tables with the learned acceleration tables includes determining, via the learn driver acceleration application, whether to use the learned average acceleration table or the scaled acceleration table.

7. The method of claim 1, wherein the vehicle parameters include speed parameters.

8. The method of claim 7, wherein generating the delta velocity includes generating the delta velocity based on the speed parameters.

9. The method of claim 8, further including generating, via the learn driver acceleration application, the learned acceleration tables based on the delta velocity.

10. A learn driver acceleration system comprising:
data processing hardware; and
memory hardware in communication with the data processing hardware, the memory hardware storing instructions that when executed on the data processing hardware cause the data processing hardware to perform operations comprising:
receiving, at a learn driver acceleration application, one or more of vehicle parameters and environmental parameters;
estimating, based on at least one of the vehicle parameters and the environmental parameters, a set speed of a vehicle;
generating, based on the estimated set speed of the vehicle, a delta velocity;
estimating, based on at least one of the vehicle parameters and the environmental parameters, a requested torque;
determining, based on the estimated requested torque, a longitudinal acceleration of the vehicle;
generating, via the learn driver acceleration application, learned acceleration tables based on at least one of the delta velocity, the requested torque, and the longitudinal acceleration of the vehicle; and
replacing, via the learn driver acceleration application, calibration tables with the generated learned acceleration tables.

11. The learn driver acceleration system of claim 10, wherein the learned acceleration tables include a learned average acceleration table and a learned maximum acceleration table and the calibration tables include an acceleration request table and a calibrated maximum acceleration table.

12. The learn driver acceleration system of claim 11, wherein replacing the calibration tables with the learned acceleration tables includes replacing the calibrated maximum acceleration table with the learned maximum acceleration table.

13. The learn driver acceleration system of claim 11, further including determining, based on the learned acceleration tables and the calibration tables, an average ratio.

14. The learn driver acceleration system of claim 13, further including generating, based on the determined average ratio, a scaled acceleration table.

15. The learn driver acceleration system of claim 14, wherein replacing the calibration tables with the learned acceleration tables includes determining, via the learn driver acceleration application, whether to use the learned average acceleration table or the scaled acceleration table.

16. The learn driver acceleration system of claim 10, wherein the vehicle parameters include speed parameters.

17. A learn driver acceleration system for a vehicle, the learn driver acceleration system comprising:
data processing hardware; and
memory hardware in communication with the data processing hardware, the memory hardware storing instructions that when executed on the data processing hardware cause the data processing hardware to perform operations comprising:
receiving, at a learn driver acceleration application, one or more of vehicle parameters and environmental parameters;
estimating, based on at least one of the vehicle parameters and the environmental parameters, a set speed of a vehicle;
generating, based on the estimated set speed of the vehicle, a delta velocity;
estimating, based on at least one of the vehicle parameters and the environmental parameters, a requested torque;
determining, based on the estimated requested torque, a longitudinal acceleration of the vehicle;
generating, via the learn driver acceleration application, learned acceleration tables based on at least one of the delta velocity, the requested torque, and the longitudinal acceleration of the vehicle, the learned acceleration tables including a learned average acceleration table and a learned maximum acceleration table;
replacing, via the learn driver acceleration application, a calibrated maximum table of calibration tables of a cruise control system with the generated learned maximum acceleration table;
determining, based on the learned acceleration tables and the calibration tables, an average ratio; and
generating, based on the determined average ratio, a scaled acceleration table.

18. The learn driver acceleration system of claim 17, further including determining, via the learn driver acceleration application, whether to use the learned average acceleration table or the scaled table.

19. The learn driver acceleration system of claim 17, wherein the vehicle parameters include speed parameters and generating the delta velocity includes generating the delta velocity based on the speed parameters.

20. The learn driver acceleration system of claim 19, further including generating, via the learn driver acceleration application, the learned acceleration tables based on the delta velocity.
